(19) United States
(12) Patent Application Publication
(10) Pub. No.: US 2002/0033114 A1
(43) Pub. Date: Mar. 21, 2002

(54) Antifouling paint composition and product coated therewith

(75) Inventors: Masumi Suehiro, Chiba (JP); Hideyuki Kurata, Chiba (JP); Takayuki Endo, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: ASAHI GLASS COMPANY, LIMITED, Tokyo (JP)

(21) Appl. No.: 09/962,582

(22) Filed: Sep. 26, 2001

Related U.S. Application Data
(63) Continuation of application No. PCT/JP01/00539, filed on Jan. 26, 2001.

(30) Foreign Application Priority Data
Jan. 26, 2000 (JP) 2000-21871

(51) Int. Cl. C09D 5/14

(52) U.S. Cl. 106/15.05

(57) ABSTRACT

An antifouling paint composition which comprises (a) a non-hydrolyzable polymer having a film-forming property and a Young's modulus of from 0.01 to 10 MPa at 25° C. in its unvulcanized state, (b) a solid antifouling substance and (c) a dispersing medium or a solvent. The composition can be readily applied to a substrate and the resulting coated film on the substrate has an excellent antifouling property for a long period. An antifouling painted product is obtained by coating the antifouling paint composition on a substrate.

### TECHNICAL FIELD

The present invention relates to an antifouling paint composition which can impart an excellent antifouling property such as an adhesive or deposition resistant property against organisms living in water, to various materials to be employed in sea water or in fresh water, and a product coated therewith.

### BACKGROUND ART

Various organisms living in water such as shellfishes, crustaceans and algae will adhere or deposit on the surface of various materials located in sea water or in fresh water, such as construction structures, ships, water intaking pipes, fishing nets and buoys. This causes bad influences on their performance as well as their outer appearance. For example, organisms and plants living in sea water such as blue mussel, an acorn shell, a conch shell, serubura, a sea lettuce and green laver will adhere in large quantity to such materials and cause the following problems:

Adverse effects on ships: decrease in sailing speed, increase in fuel consumption, and labor increase in removing adhered organisms.

Adverse effects on sea water-intaking pipes: blocking in cooling water-intaking pipes for a coastal power plant and in a heat exchanger.

Harmful effects on fish farming nets: hindrance against fish growing, and inducement of fish diseases.

Adverse effects on a film for prevention of marine pollution: sinking of a tensioned film caused by decrease in buoyancy of a float, and decrease in the function of preventing pollution.

Adverse effects on the environment caused by removing works of adhered or deposited organisms: discharging of a large quantity of wastes at a time in removing and cleaning works of adhered organisms, and detrimental effects on the environment such as fishing ground pollution.

Heretofore, as a method for solving the above-mentioned problems, prevailing has been a method wherein a paint containing an antifouling substance is coated to a substrate, and gradual elution of the antifouling substance from the coated film prevents the adhesion of organisms in water. However, in this method, elution of the antifouling substance results from the hydrolysis of the coated film resin, and thus the hydrolyzed resin will dissolve into water and the film will become thin, whereby the antifouling effect tends to decrease gradually and consequently the duration of the effect is short.

Further, with a decrease in the antifouling effect, oyster shells, acorn shells, etc. tend to adhere to the coated film and to penetrate into the inside of the coated film. As a result, they can not be readily removed therefrom. Particularly, in the case of acorn shells adhesion, it is necessary to smooth the surface sufficiently by a blast treatment, etc., before the recoating.

Further, when the hydrolysis of the coated film resin proceeds, the coated film will not be able to absorb physical impact and will be readily scratched. Consequently, repairing works will be needed. When a hydrolysable resin paint is employed, re-coating will be required in a relatively short period. Moreover, when a substrate stands still in water as in such a case of buoys, construction materials, and ships at anchor, an elution effect of antifouling substances caused by flowing water tends to decrease. Consequently, the antifouling effect will decrease gradually. Furthermore, the environmental problems come to arise, because antifouling substances dissolve into water.

### THE DISCLOSURE OF THE INVENTION

The present invention has made it possible to provide an antifouling paint composition which can be readily applied on the surface of a substrate and can form a coated film having an excellent antifouling property for a long period, and an antifouling painted product which is capable of reducing the environmental problems which has been caused by a heretofore hydrolysable resin coated film.

The present invention provides an antifouling paint composition which comprises (a) a non-hydrolyzable polymer having a film-forming property and a Young's modulus of from 0.01 to 10 MPa at 25° C. in its unvulcanized state, (b) a solid antifouling substance, and (c) a dispersing medium or a solvent.

Further, the present invention provides the antifouling paint composition wherein the component (a) is a fluorine-containing rubber, and a product comprising a substrate and the above-mentioned antifouling paint composition coated on the surface of the substrate.

### BEST MODE FOR CARRYING OUT THE INVENTION

The component (a) in the paint composition of the present invention is a non-hydrolyzable polymer having a film forming property and a Young's modulus of from 0.01 to 10 MPa at 25° C. in its unvulcanized state. The Young's modulus of the non-hydrolyzable polymer is preferably from 0.1 to 5 MPa, more preferably from 0.1 to 3.5 MPa.

When the Young's modulus is less than 0.01 MPa, the film forming property is poor and the durability of the coated film is insufficient. When the Young's modulus exceeds 10 MPa, the antifouling property is not outstanding. The component (a) is preferably a non-hydrolyzable elastomer.

The component (a) may, for example, a fluorine-containing rubber, a nitrile-butadiene rubber (NBR), an acrylic rubber, a stylene-butadiene rubber (SBR), an ethylene-propylene type rubber, an isoprene rubber, an chloroprene rubber, a butyl rubber, a silicone rubber, an urethane rubber, a natural rubber, etc. These non-hydrolyzable polymer may be used alone or as a mixture in combination.

Further, the component (a) may be used in a form of a dispersion in water or a solvent, a latex, a solution, etc. In order to increase the strength of the coated film, it is preferred to incorporate a vulcanizing agent for the component (a) into the paint composition to obtain a vulcanized coated film. Such a vulcanizing agent can be selected from vulcanizing agents to be suitably used for vulcanizing the component (a).

The fluorine-containing rubber is preferably a fluoroolefin type copolymer, and may be a mixture of at least two kind of fluoroolefin copolymers or a copolymer of fluoroolefin and the other monomer.

The fluoroolefin may, for example, be a fluoroolefin having a carbon number of from 2 to 4, such as tetrafluoroethylene, chlorotrifluoroethylene, trifluoro ethylene, vinylidene fluoride, vinyl fluoride, hexafluoropropylene, pentafluoropropylene, 2-trifluoromethyl-1,1-dichloropropylene. Particularly, tetrafluoroethylene, hexafluoropropylene and vinylidene fluoride are preferred. The fluoroolefin may be used alone or as a mixture in combination.

The above-mentioned other monomer may, for example, be a (perfluoroalkyl)ethylene such as perfluorobuthylethylene, a fluorine-containing vinyl ether such as perfluoro(methyl vinyl ether) and perfluoro(propyl vinyl ether), a fluorine-containing acrylate, a-olefin such as ethylene, propylene, and 1-butene, a vinyl ether such as ethyl vinyl ether. The other monomer may be used alone or as a mixture in combination.

When the copolymer of fluoroolefin and the other monomer is used, the amount of the polymerizing units based on the fluoroolefin is preferably from 20 to 80 mol %, more preferably from 40 to 70 mol %. The amount of the polymerizing units based on the other monomer is preferably from 20 to 80 mol %, more preferably from 30 to 60 mol %.

When the fluorine-containing rubber is used in a vulcanized state, it is preferred to use a copolymer containing the polymerizing units based on vinylidene fluoride because it can be readily vulcanized. The fluorine-containing rubber comprising vinylidene fluoride copolymer is preferably a copolymer of vinylidene fluoride and at least another fluoroolefin. The amount of the polymerizing units based on vinylidene fluoride in the fluorine-containing rubber comprising vinylidene fluoride is preferably from 0.5 to 90 mol %, more preferably from 1 to 85 mol %.

The fluorine-containing rubber is preferably a tetrafluoroethylene-propylene type copolymer, a vinylidene fluoride-tetrafluoroethylene-propylene type copolymer, a vinylidene fluoride-hexafluoropropylene type copolymer or a vinylidene fluoride-hexafluoropropylene-tetrafluoroethylene copolymer. These copolymer may be used alone or as a mixture in combination.

As a method for producing such a fluorine-containing rubber to be used for the component (a), it is possible to use various known polymerization methods such as a bulk polymerization, a suspension polymerization, an emulsion polymerization and a solution polymerization. While the number-average molecular weight of the fluorine-containing rubber may be suitably selected, it is preferably from 3,000 to 1,000,000, more preferably from 10,000 to 30,000.

When the coated film is formed by using the fluorine-containing rubber as the component (a), it may be formed in its vulcanized state or in its unvulcanized state. The vulcanization can be carried out by employing a usual vulcanizing agent in a usual manner to be used for vulcanizing a fluorine-containing rubber.

In the case where an organic peroxide is used as a vulcanizing agent for a fluorine-containing rubber, it is preferred to introduce a vulcanization site by copolymerizing a bromine-containing monomer or by using a iodine-containing chain-transfer agent. When the vulcanization site is not introduced, it is possible to employ, as a vulcanization accelerator, an organic onium compound, such as an organic quaternary ammonium salt or an organic quaternary phosphonium salt, a nitrogen-containing organic compound such as an amine and an imine, an organophosphorus compound such as phosphine and phosphite. When the vulcanization site is introduced, a multi-functional unsaturated compound may be employed as a vulcanization co-agent. When the vulcanization accelerator is used, an oxide or a hydroxide of a bi-valent metal may be simultaneously used as an acid acceptor.

The organic peroxide may, for example, be benzoyl peroxide, dichlorobenzoyl peroxide, dicumyl peroxide, 1,4-bis(tert-butylperoxyisopropyl)benzene, lauroyl peroxide, tert-butyl peracetate, 2,5-dimethyl-2,5-di(tert-butylperoxy)hexyne-3, 2,5-dimethyl-2,5-di(peroxybenzoate)hexyne-3, 2,5-dimethyl-2,5-di(tert-butylperoxy)hexane, tert-butyl perbenzoate, tert-butyl perphenylacetate, etc.

The unsaturated multi-functional compound may, for example, be triallyl isocyanurate, triallyl cyanurate, trimethylolpropane trimethyl acrylate, polybutadiene, etc.

The vulcanization accelerator may, for example, be an organic onium compound such as tetrabutylammonium hydrogensulfate, tetrabutylammonium bromide, 8-benzyl-1, 8-diazabicyclo[5,4,0]undeca-7-enium chloride, p-toluene sulfonic acid 1,8-diazabicyclo[5,4,0]undeca-7-enium tetrabutylphosphonium chloride and triphenylbenzyl phosphonium chloride, 1,8-diazabicyclo[5,4,0]undecene-7, pyridine, tributyl amine, triphenyl phosphine and tributyl phosphite. In this case, the acid acceptor may be an oxide or a hydroxide of magnesium, calcium, zinc, lead, etc.

When a polyhydroxy compound is used as a vulcanizing agent for the fluorine-containing rubber, it is preferred to use an organic onium compound as a vulcanization accelerator and an oxide or a hydroxide of bi-valent metal as an acid acceptor, respectively.

The polyhydroxy compound may be a compound known for the vulcanization of a fluorine-containing rubber. It is preferred to use an aromatic polyhydroxy compound such as bisphenol AF, bisphenol A and hydroquinone.

The organic onium compound may be a compound known for the vulcanization of a fluorine-containing rubber. Preferred are a quaternary phosphonium chloride such as triphenylbenzyl phosphonium chloride, trioctylmethyl phosphonium chloride, an ammonium salt such as tetrabutyl ammonium bromide, tetrabutyl ammonium hydrogensulfate, 8-benzyl-1, 8-diazabicyclo[5,4,0]-undeca-7-enium chloride, an iminium salt and a sulfonium salt. In this case, the acid acceptor may be an oxide or a hydroxide of magnesium, calcium, zinc, lead, etc.

When a polyamine compound is used as a vulcanizing agent for the fluorine-containing rubber, the acid acceptor may be an oxide or a hydroxide of bi-valent metal.

The polyamine compound may be a compound known for the vulcanization of a fluorine-containing rubber. It is preferred to use hexamethylene diamine, hexamethylene diamine dicarbamate, dicinnamylidene hexamethylene diamine, etc.

The kind and amount of the vulcanizing agent to be used in the present invention may be suitably selected depending on the uses and the manner to be employed for the antifouling composition. The vulcanization conditions may be determined by the working conditions, etc. For example, the temperature is usually from 100° C. to 400° C. and the time is usually from a few seconds to 24 hours.

When a rubber material other than the fluorine-containing rubber is used, as the component (a) in its vulcanized state, the vulcanizing agent to be used may be the following one. In the case of a natural rubber, NBR, SBR, an ethylene-propylene type rubber or an isoprene rubber, preferred are sulfur or an organic peroxide. In the case of a butyl rubber, preferred are sulfur or a quinone dioxime. In the case of an acrylic rubber, preferred are a metal soap or a polyamine. In the case of a chloroprene rubber, preferred are a metal oxide or a metal peroxide. In the case of a silicone rubber, preferred are an organic peroxide, a multifunctional polysiloxane or a multifunctional silane compound. In the case of an urethane rubber, preferred are a diisocyanate, a diamine or an organic peroxide.

The component (b) is a solid antifouling substance. The average diameter of the component (b) is preferably from 0.1 to 100 μm. Its specific surface area is preferably at least 50 m²/g, more preferably at least 100 m²/g.

The kind and amount of the solid antifouling substance as the component (b) may be suitably selected depending on the use and the purpose of the antifouling composition. The component (b) may, for example, be a generally known antifouling substance such as an organotin compound, an organochlorine compound, a thiuram compound, a carbamate type compound, a copper-containing compound, an arsenic compound and a zinc.lead containing compound, an antibacterial agent (such as a titanium oxide type, a silver type), etc. Such a compound may be used alone or as a mixture of two or more in combination. For example, copper(I) oxide is preferred in the case of preventing from adhesion of an acorn shell. Copper pyrithione or zinc pyrithione is preferred in the case of preventing sea weeds from adhesion. The component (b) may be mixed into the component (a) in advance, or may be blended into the mixture of the component (a) and the component (c).

The amount of the component (b) is preferably from 0.1 to 1000 parts, more preferably from 0.1 to 500 parts, especially preferably from 1 to 100 parts, relative to 100 parts of the component (a). In the present description, “parts” means “parts by mass”.

The component (c) is a dispersion medium or a solvent. A specific example of the component (c) may be an ester such as ethyl acetate and butyl acetate, a ketone such as acetone, methyl ethyl ketone, methyl isobutyl ketone and cyclohexanone, an alcohol such as methanol and ethanol, a hydrocarbon such as hexane, octane, toluene, xylene, naphtha and gasoline, water, etc. These may be used alone or a mixture in combination.

The amount of the component (c) is not particularly limited, and may be suitably selected depending on the use and the purpose of the antifouling composition. Usually, the amount is preferably from 10 to 5000 parts, more preferably from 50 to 2000 parts, especially preferably from 100 to 1000 parts, relative to 100 parts of the component (a).

While the method for applying the antifouling paint composition of the present invention to a substrate is not particularly limited, a method such as a spray method, a coater method, a dipping method, a brush coating method, an electrostatic coating method, etc is preferably employed. The coated film can be formed by applying the paint composition followed by drying and if necessary, by vulcanization. At the steps of drying and vulcanization, the component (c) may evaporate and be removed from the coated film.

The thickness of the coated film is not particularly limited, and may be preferably within the range of from 1 μm to 3 mm, particularly preferably from 10 μm to 1 mm.

When the antifouling coated film is formed on a substrate in the manner mentioned above, it is preferred to treat previously the surface of the substrate with a primer. It is also preferred to add such a primer to the antifouling paint composition of the present invention.

As the primer, preferred are various kinds of the primers such as a silane coupling agent, a titanate type coupling agent, an epoxy type primer, and a silane coupling agent is preferred. Such a silane coupling agent is more preferably 3-aminopropyltrimethoxy silane, 3-aminopropyltriethoxy silane, 3-aminopropyltripropoxy silane, etc.

When the primer is added to the antifouling paint composition of the present invention, the amount of the primer may be suitably selected depending on the shape of a substrate to be coated and environmental conditions under which the substrate is disposed. Usually, the amount is preferably from 0.1 to 10 parts, relative to the component (a).

It is also preferred that the component (b) is immobilized and held in the antifouling coated film in a reticulated form or in a porous form. The component (a) may function as a binder for immobilizing the component (b), and at the same time may be adherently or coherently coated on the surface of a substrate so that the substrate will be protected for a long period. The mechanism by which the advantages of the present invention are attained is not necessarily evident. However, the component (b) having an antifouling property may be held in the coated film containing the component (a) so that the component (b) tends to be hardly eluded into water. Moreover, the component (b) can constantly contact targeted organisms whereby the antifouling effect will be kept for a long period, because it is not influenced by the surrounding environment, for example, the exterior surface of the bottoms of ships where the surrounding water is always flowing and a place such as surroundings of a buoy or fishing nets where the surrounding water is not flowing.

The substrate on the surface of which the antifouling paint composition of the present invention is applied may be suitably selected depending on the uses and the purpose of the antifouling composition. The substrate may, for example, be a metal material such as steal, stainless steal, titanium and copper, an organic material such as glass fiber reinforced plastics (FRP) and polyvinyl chloride (PVC), stone, concrete, ceramics, glass, etc.

The coated film obtained by the antifouling paint composition of the present invention possesses elasticity and ability to absorb physical impact, whereby the coated substrate may be hardly scratched and the repairing works tend to be extremely reduced. If the coated film is partly scratched, it will be readily repaired by coating the antifouling paint composition on such a part.

So far as the antifouling effect is not extremely impaired, a filler such as silica, carbon, glass fibers and inorganic fillers, a pigment, a plasticizing agent, an adhesive, a synthetic or a natural organic material may be optionally added to the antifouling paint composition of the present invention. For example, the addition of fluororesin particles can improve the water and oil repellency, and the addition of a metal oxide can improve the abrasion resistance.

The antifouling painted product of the present invention can be employed in extensive fields, regardless of sea water or fresh water and whether water is flowing or not. The following examples may be mentioned; a moored vessel, an artificial floating island, a ship at an anchor, a floating buoy, a water intaking facility of sea water or fresh water for such as an atomic power plant equipment, a water path for draining facility, a water treatment equipment for such as a cooling tower, a construction material for such as a water reservoir, a construction material contacting sea water, etc.

### EXAMPLES

In the following, the present invention will be described in detail with reference to examples, but the present invention is not limited thereto. Examples 1-6 and Examples 9-14 are embodiments of the present invention, and Examples 7-8 and Examples 15-17 are comparative examples.

[Preparation Example 1]

A fluorine-containing rubber composition was obtained by mixing 100 parts of a fluorine-containing rubber composed of polymerizing units of tetrafluoroethylene/propylene (molar ratio: 55/45) and having a Young's modulus of 3.15 MPa at 25° C. in its unvulcanized state and 10 parts of MT carbon (N 990, manufactured by CANCARB company). 100 parts of the fluorine-containing rubber composition was homogeneously dispersed into 400 parts of butyl acetate to obtain a base paint 1.

[Preparation Example 2]

100 parts of a fluorine-containing rubber composed of polymerizing units of vinylidene fluoride/tetrafluoroethylene/propylene (molar ratio: 3/55/42) and having a Young's modulus of 1.42 MPa at 25° C., 10 parts of MT carbon (N 990, manufactured by CANCARB Company) and 3 parts of magnesium oxide (Kyowamag 150, manufactured by Kyowa Chemical Industries Company Limited), 6 parts of calcium hydroxide (Calvit, manufactured by Ohmi Chemical Company), 1 part of bisphenol AF and 0.5 parts of tetrabutylammonium hydroxide) were homogeneously mixed by using two-roll mill to obtain a fluorine-containing rubber composition.

100 Parts of the resulting fluorine-containing rubber composition was homogeneously dispersed into 400 parts of ethyl acetate to obtain a base paint 2.

[Preparation Example 3]

100 parts of a fluorine-containing rubber composed of polymerizing units of vinylidene fluoride/tetrafluoroethylene/hexafluoropropylene (molar ratio: 60/22/18) and having a Young's modulus of 0.86 MPa at 25° C. was homogeneously dispersed into 400 parts of methyl ethyl ketone to obtain a base paint 3.

[Preparation Example 4]

100 parts of a fluorine-containing rubber composed of polymerizing units of vinylidene fluoride/tetrafluoroethylene/hexafluoropropylene (molar ratio: 60/22/18) and having a Young's modulus of 0.31 MPa at 25° C., 30 parts of N 990, 3 parts of Kyowamag 150, 6 parts of Calvit, 2 parts of bisphenol AF, 0.5 parts of triphenylbenzyl phosphonium chloride and 1 part of 3-aminopropyltriethoxysilane were homogeneously mixed to obtain a fluorine-containing rubber composition.

100 parts of the resulting fluorine-containing rubber composition was homogeneously dispersed into 400 parts of methyl ethyl ketone to obtain a base paint 4.

[Preparation Example 5]

A natural rubber composition was obtained by mixing 100 parts of a natural rubber having a Young's modulus of 0.25 MPa at 25° C. and 30 parts of HAF carbon (Asahi #70, manufactured by Asahi Carbon Company). 100 Parts of the natural rubber composition was homogeneously dispersed into 400 parts of gasoline to obtain a base paint 5.

[Preparation Example 6]

100 parts of a nitrile rubber (NBR) having a Young's modulus of 0.92 MPa at 25° C., 100 parts of mistron vaper talc, 3 parts of zinc oxide No. 1, 1 part of stearic acid, 5 parts of octylated diphenyl amine (NOCRAC AD-F, manufactured by Ouchishinko Chemical Industrial Co., Ltd.), 2.5 parts of tetramethyl thiuram disulfide (NOCCELER TT, manufactured by Ouchishinko Chemical Industrial Co., Ltd.), 2 parts of tetrabutyl thiuram disulfide (NOCCELER TBTS, manufactured by Ouchishinko Chemical Industrial Co., Ltd.) and 0.4 parts of sulfur were mixed to obtain a NBR composition.

100 parts of the resulting NBR composition was homogeneously dispersed into 700 parts of cyclohexanone to obtain a base paint 6.

[Preparation Example 7]

100 parts of a fluorine-containing rubber composed of polymerizing units of vinylidene fluoride/tetrafluoroethylene/propylene (molar ratio: 35/40/25) and having a Young's modulus of 0.002 MPa at 25° C., 10 parts of N 990, 3 parts of Kyowamag 150, 6 parts of Calvit, 1 part of bisphenol AF and 0.5 parts of tetrabutyl ammonium hydroxide were homogeneously mixed by using two-roll mill to obtain a fluorine-containing rubber composition.

100 parts of the resulting fluorine-containing rubber composition was homogeneously dispersed into 400 parts of ethyl acetate to obtain a base paint 7.

[Preparation Example 8]

100 parts of a fluorine-containing rubber composed of polymerizing units of vinylidene fluoride/tetrafluoroethylene/hexafluoropropylene (molar 15 ratio: 50/40/10) and having a Young's modulus of 57 MPa at 25° C. was homogeneously dispersed into 400 parts of methyl ethyl ketone to obtain a base paint 8.

[Examples 1-6] and [Examples 7-8 (Comparative Examples)]

Paint 1-Paint 8 were obtained by adding various solid antifouling substances to the base paints with stirring at room temperature in the ratio shown in Table 1. The solid antifouling substances were copper(I) oxide (average particle diameter: 2.5 μm, specific surface area: 4500 m²/g, manufactured by Kanto Chemical Company), zinc pyrithione (average particle diameter: 7.5 μm, specific surface area: 2000 m²/g, ZINC OMADINE, manufactured by Arch Chemical Company) and copper pyrithione (average particle diameter: 5.0 μm, specific surface area: 2500 m²/g, COPPER OMADINE, manufactured by Arch Chemical Company).

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| | Paint 1 | Paint 2 | Paint 3 | Paint 4 | Paint 5 | Paint 6 | Paint 7 | Paint 8 |
| Base Paint 1 | 60 | | | | | | | |
| Base Paint 2 | | 60 | | | | | | |
| Base Paint 3 | | | 60 | | | | | |
| Base Paint 4 | | | | 60 | | | | |
| Base Paint 5 | | | | | 60 | | | |
| Base Paint 6 | | | | | | 60 | | |
| Base Paint 7 | | | | | | | 60 | |
| Base Paint 8 | | | | | | | | 60 |
| Copper (I) | 10 | 10 | 30 | 30 | 50 | 50 | 10 | 30 |
| oxide | | | | | | | | |
| Zinc | 3 | 3 | 5 | 5 | 5 | 5 | 3 | 5 |
| pyrithione | | | | | | | | |
| Copper | 5 | 5 | 5 | 3 | 5 | 5 | 5 | 3 |
| pyrithione | | | | | | | | |

[Example 9]

The paint 1 was coated uniformly with a brush on the plate made of stainless steal (SUS 304) having a size of 30 cm×30 cm and dried at room temperature for 24 hours to obtain a test piece having a coated film (thickness: 30 μm) comprising a fluorine-containing rubber. The test piece was fixed to the side wall of a raft floating on the sea of an inner bay at Ichihara city in Chiba prefecture, so that the upper ⅕ part of the test piece was always come out from sea level regardless of high and low tides.

The immersion-exposure test was carried out in the above way. The adhesion of organisms to the test piece and the change of the surface state of the test piece by the adhered organisms with a passage of time were evaluated with the eyes. The raft was moored at a jetty so that it was not influenced by water flow in comparison with a sailing ship, etc. Consequently, the conditions employed in this immersion-exposure test were severe from the viewpoint of adhesion of organisms.

[EXAMPLE 10]

The paint 2 was coated uniformly with a brush on the plate made of glass fiber-reinforced polyvinyl chloride (manufactured by Asahi Glass Engineering Company) having a size of 30 cm×30 cm and dried at 200° C. for 30 minutes to obtain a test piece having a coated film (thickness: 30 μm) comprising a fluorine-containing rubber.

The immersion-exposure test of the test piece was carried out in the same manner as in Example 9.

[Example 11]

The immersion-exposure test was carried out using the sample obtained in the same manner as in Example 9 except that Paint 3 and a titanium plate were used instead of Paint 1 and a stainless steal plate, respectively.

[Example 12]

The immersion-exposure test was carried out using the sample in the same manner as in Example 10 except that Paint 4 and a polyvinyl chloride plate were used instead of Paint 2 and a FRV-R plate, respectively.

[EXAMPLE 13]

The immersion-exposure test was carried out using the sample in the same manner as in Example 9 except that Paint 5 was used instead of Paint 1.

[Example 14]

The immersion-exposure test of was carried out using the sample in the same manner as in Example 10 except that Paint 6 was used instead of Paint 2.

[Example 15 (Comparative Example)]

The immersion-exposure test was carried out using the sample in the same manner as in Example 1 except that Paint 9 was used instead of Paint 2.

[Example 16 (Comparative Example)]

The immersion-exposure test was carried out using the sample in the same manner as in Example 9 except that Paint 10 was used instead of Paint 3.

[Example 17 (Comparative Example)]

The immersion-exposure test was carried out using the sample in the same manner as in Example 9 except that YEAL Paint NO. 1 (manufactured by NIPPON PAINT CO., LTD.) was used instead of Paint 3.

The results of the immersion-exposure tests of Examples 9-17 are shown in Table 2. ∘no adhesion of organisms was observed. Δ: a small amount of adhesion of sea weeds were observed. X: adhesion of acorn shells and sea weeds were observed. XX: a large quantity of adhesion of organisms was observed.

TABLE 2

| | | | Days of immersion-exposure (day) | | |
|---|---|---|---|---|---|
| | Substrate | Paint | 65 | 300 | 700 |
| Ex. 9 | Stainless | Paint 1 | $ | $ | $ |
| | Steal | | | | |
| Ex. 10 | FRV-R | Paint 2 | ∘ | ∘ | ∘ |
| Ex. 11 | Titanium | Paint 3 | ∘ | ∘ | ∘ |
| Ex. 12 | PVC | Paint 4 | ∘ | ∘ | ∘ |
| Ex. 13 | Stainless | Paint 5 | ∘ | ∘ | Δ |
| | Steal | | | | |
| Ex. 14 | FRV | Paint 6 | ∘ | ∘ | Δ |
| Ex. 15 | FRV | Paint 7 | X | XX | XX |
| Ex. 16 | Titanium | Paint 8 | X | XX | XX |
| Ex. 17 | Stainless | YEAL Paint | X | X | XX |
| | Steal | No. 1 | (Partially) | | |

### INDUSTRIAL APPLICABILITY

According to the present invention, a new antifouling paint composition was provided.

The composition can be readily applied to the surface of a substrate and the resulting film on the substrate has an excellent antifouling property for a long period.

An antifouling painted product is also provided by coating the antifouling paint composition on a substrate.

The entire disclosure of Japanese Patent Application No. 2000-21871 filed on Jan. 26, 2000 including specification, claims and summary are incorporated herein by reference in its entirety.

1. An antifouling paint composition which comprises (a) a non-hydrolyzable polymer having a film-forming property and a Young's modulus of from 0.01 to 10 MPa at 25° C., in its unvalcanized state, (b) a solid antifouling substance, and (c) a dispersing medium or a solvent.

2. The antifouling paint composition according to claim 1, wherein the component (a) is a fluorine-containing rubber.

3. The antifouling paint composition according to claim 2, wherein the fluorine-containing rubber is a tetrafluoroethylene-propylene type copolymer, a vinylidene fluoride-tetrafluoroethylene-propylene type copolymer, a vinylidene fluoride-hexafluoropropylene type copolymer or a vinylidene fluoride-hexafluoropropylene-tetrafluoroethylene type copolymer.

4. The antifouling paint composition according to claim 1, wherein the component (b) is copper(I) oxide, copper pyrithione or zinc pyrithione.

5. The antifouling paint composition according to claim 1, wherein the component (c) is an ester, a ketone, an alcohol, a hydrocarbon or water.

6. The antifouling paint composition according to claim 1, wherein the amount of the component (b) is from 0.1 to 1000 parts by mass and the amount of the component (c) is from 10 to 5000 parts by mass, relative to 100 parts by mass of the component (a).

7. The antifouling paint composition according to claim 1, wherein the amount of the component (b) is from 0.1 to 500 parts by mass and the amount of the component (c) is from 50 to 2000 parts by mass, relative to 100 parts by mass of the component (a).

8. The antifouling paint composition according to claim 1, wherein the amount of the component (c) is from 0.1 to 100 parts by mass and the amount of the component (c) is from 100 to 1000 parts by mass, relative to 100 parts by mass of the component (a).

9. The antifouling paint composition according to claim 1, wherein the component (a) has a Young's modulus of 0.1 to 5 MPa at 25° C. in its unvulcanized state.

10. The antifouling paint composition according to claim 1, wherein the component (a) has a Young's modulus of 0.1 to 3.5 MPa at 25° C. in its unvulcanized state.

11. The antifouling paint composition according to claim 2, which contains, in addition to the component (a), the component (b) and the component (c), a vulcanizing agent, a vulcanization accelerator and an acid acceptor.

12. The antifouling paint composition according to claim 11, wherein the vulcanizing agent is a polyhydroxy compound, the vulcanization accelerator is an organic onium compound, and the acid acceptor is an oxide or a hydroxide of a bi-valent metal.

13. The antifouling paint composition according to claim 11, wherein the vulcanizing agent is an organic peroxide, the vulcanization accelerator is an organic onium compound, vulcanizing co-agent is a multifunctional unsaturated compound, and the acid acceptor is an oxide or a hydroxide of a bi-valent metal.

14. A product comprising a substrate and the antifouling paint composition as defined in claim 1 coated on the surface of the substrate.
